(19) United States
(12) Patent Application Publication
(10) Pub. No.: US 2015/0029851 A1
(43) Pub. Date: Jan. 29, 2015

(54) MANAGING THE TRAFFIC LOAD OF A DELIVERY NODE

(71) Applicants: Lawrence Haydock, Sainte-Adele (CA); Nazin Hossain, Brossard (CA); Zhongwen Zhu, Saint-Laurent (CA)

(72) Inventors: Lawrence Haydock, Sainte-Adele (CA); Nazin Hossain, Brossard (CA); Zhongwen Zhu, Saint-Laurent (CA)

(73) Assignee: TELEFONAKTIEBOLAGET L M ERICSSON (PUBL), Stockholm (SE)

(21) Appl. No.: 13/951,552

(22) Filed: Jul. 26, 2013

(51) Int. Cl. H04L 12/803

(52) U.S. Cl. CPC H04L 47/125
USPC 370/235

(57) ABSTRACT

The invention relates to a method for managing the traffic load of a delivery node being in a state BLOCKED or UNBLOCKED. The method comprises the step determining that the traffic load of the delivery node is within a pair of upper and lower limits. The method also comprise the step of changing the state of the delivery node upon the determination that the traffic load of a delivery node is within the pair of upper and lower limits. Changing the state is changing from UNBLOCKED to BLOCKED or from BLOCKED to UNBLOCKED. The invention also relates to a delivery node suitable for implementing the method disclosed hereinabove.

### TECHNICAL FIELD

The present invention relates to the field of content delivery network (CDN) and more particularly to managing the traffic load of a delivery node.

### BACKGROUND

It is predicted that in the next years the biggest part of traffic over networks will remain video. To stay profitable, network owners want to minimize their capital expenditures and reduce operating costs, but at the same time they want to provide a good Quality of Experience (QoE) to content consumers (CC). Unused network infrastructure results in increased costs; overloaded network infrastructure results in poor QoE. To minimize their costs while providing a good QoE, network owners aim to operate their infrastructure at an optimal level of performance.

The existing technologies can leave the delivery nodes (DNs) and network infrastructure over utilized or underutilized. Overutilization occurs because a correction mechanism is only applied after some measurement of network performance crosses a threshold indicating a degradation of the network performance. By that time, the Quality of Experience (QoE) has already been impacted.

On the other hand, existing technologies can leave delivery nodes and network infrastructure underutilized due to several factors. For example, the traffic load on the delivery node, or on a cluster, can drop well below a low load mark, and the traffic is not directed there because the system reaction time is too slow. Such circumstances can occur because the mechanism to sample traffic load, collect information and make decisions, and then modify the pool of candidates, is external to the delivery nodes and too expensive in terms of overhead to run frequently.

Underutilization can also occur when the traffic load comes in bursts and results in changes in load occurring relatively fast compared to a slower reaction time. Underutilization can further occur when traffic load is not balanced efficiently throughout the delivery nodes or when bitrate throttling causes data to move through the network at a rate less than the capacity of the network infrastructure, thus creating inefficiencies, bottlenecks and network performance loss. Alternatively, the time to resume after an overutilization can be too slow, resulting also in an underutilization.

Existing technologies generally focus on preventing overload situations by limiting the quantity of new requests or by restricting overall traffic. For example, the traffic load is monitored on the nodes, and an overloaded node is temporarily removed from the pool of candidates available to provision new sessions until its traffic load subsides to an acceptable level. Traditional constraint-based traffic flow optimization systems monitor network performance and react when the network performance crosses constraints e.g. high mark and low mark thresholds. To correct overload situations, these systems remove a node from the pool when the traffic it serves rises above the high mark threshold and then resume normal unrestrained operation of the node when the traffic decreases below the low mark threshold. Alternative optimization systems can also restrict traffic load towards some nodes through throttling mechanisms such as bitrate throttling or transaction throttling.

Typically, these mechanisms are applied by a control mechanism that resides externally to the delivery nodes such as a controller or a redirector which might collect

Simple Network Management Protocol (SNMP) counter information or process log files to determine traffic load, or monitor traffic by some other means and to take action when a node or cluster is underutilized or over utilized.

### SUMMARY

It is therefore an object to provide a method and delivery node that obviate or mitigate at least some of the above described disadvantages.

There is provided a method for managing the traffic load of a delivery node being in a state BLOCKED or UNBLOCKED. The method comprises the step of determining that the traffic load of the delivery node is within a pair of upper and lower limits and the step of changing the state of the delivery node upon the determination that the traffic load of a delivery node is within the pair of upper and lower limits. Changing the state means changing from UNBLOCKED to BLOCKED or from BLOCKED to UNBLOCKED.

There is also provided a delivery node comprising a processor and memory. The memory contains instructions executable by the processor for managing the traffic load of the delivery node which is in a state BLOCKED or UNBLOCKED. The delivery node is operative to determine that the current traffic load of the delivery node is within a pair of upper and lower limits and change the state of the delivery node upon the determination that the traffic load of the delivery node is within the pair of upper and lower limits. The state is changed from UNBLOCKED to BLOCKED or from BLOCKED to UNBLOCKED.

### BRIEF DESCRIPTION OF THE DRAWINGS

FIG. 1 illustrates a portion of a content delivery network with traditional traffic distribution.

FIG. 2 illustrates a portion of a content delivery network with traffic distribution according to an exemplary embodiment.

FIG. 3 illustrates steps of a method according to an exemplary embodiment.

FIG. 4 is a flowchart illustrating steps of a method according to another exemplary embodiment.

FIG. 5 is a graph illustrating an exemplary result of an execution of the methods of FIG. 3 or 4.

FIG. 6 illustrates a delivery node according to an exemplary embodiment.

### DETAILED DESCRIPTION

The various features of the invention will now be described with reference to the figures. These various aspects are described hereafter in greater detail in connection with exemplary embodiments and examples to facilitate an understanding of the invention, but should not be construed as limited to these embodiments. Rather, these embodiments are provided so that the disclosure will be thorough and complete, and will fully convey the scope of the invention to those skilled in the art.

Many aspects of the invention are described in terms of sequences of actions or functions to be performed by elements of a computer system or other hardware capable of executing programmed instructions. It will be recognized that the various actions could be performed by specialized circuits, by program instructions being executed by one or more processors, or by a combination of both. Moreover, the invention can additionally be considered to be embodied entirely within any form of computer readable carrier or carrier wave containing an appropriate set of computer instructions that would cause a processor to carry out the techniques described herein.

In some alternate implementations, the functions/acts may occur out of the order noted in the sequence of actions. Furthermore, in some illustrations, some blocks may be optional and may or may not be executed; these are generally illustrated with dashed lines.

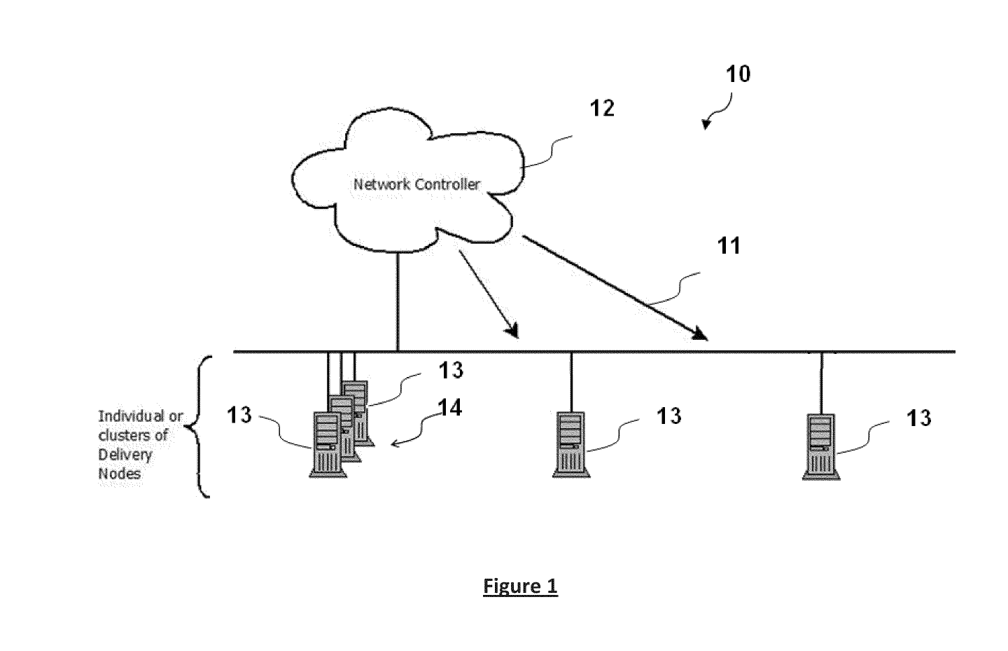

FIG. 1 illustrates a portion of a content delivery network 10 with traditional traffic distribution. Within the context of content delivery networks, new requests for content are redirected 11 from the network controller 12 to the best fit delivery node (DN) 13, or cluster 14 of delivery nodes 13, based on various criteria including location of content and geographical proximity of the delivery node 13, or cluster 14, to the content consumer (CC). It should be noted that the cluster 14 can be any type of cluster known in the art but that individual delivery nodes of the cluster 14 implement the method described herein. The cluster is a group of delivery nodes that work together to service a higher density of content consumers in a geographical area. When a delivery node 13 exceeds some traffic load degradation high mark, the delivery node 13 is removed from the pool of available delivery nodes by the network controller 12 and no new sessions are redirected to that delivery node 13 to be provisioned until the traffic load subsides below a traffic load low mark, the resume mark. At that time the delivery node 13 is added back to the pool by the network controller 12. In this illustration, the cluster 14 of delivery nodes has been removed from the pool of available delivery nodes because all the delivery nodes therein are in a BLOCKED state and all new requests are being dispatched to one of the standalone delivery nodes 13 based on best fit.

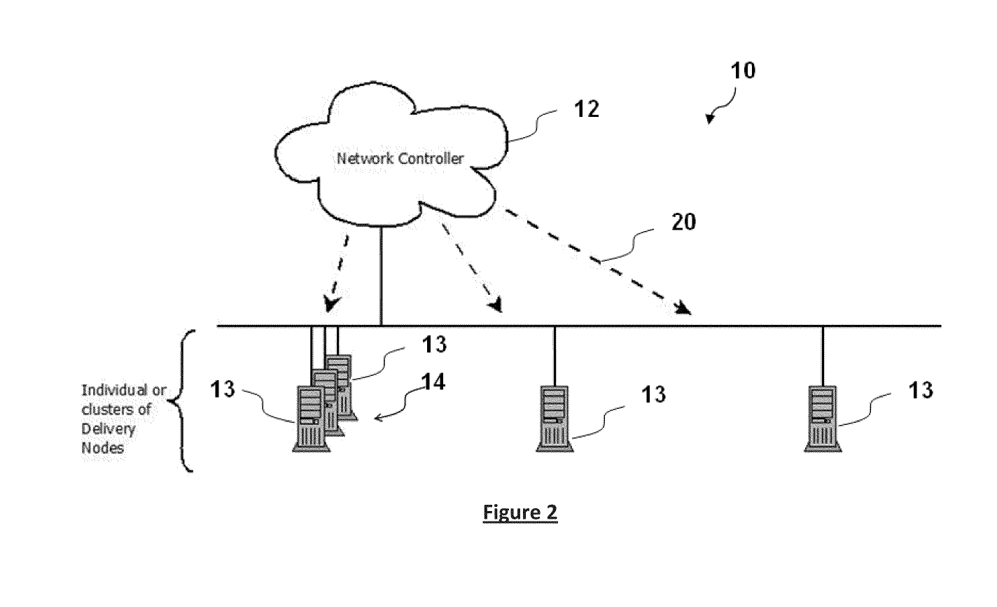

FIG. 2 illustrates a portion of a content delivery network 10 with pulse based traffic distribution i.e. where traffic is sent in bursts and is alternately stopped at predetermined intervals. Network controller 12 redirects 20 new requests traffic through the network in very short bursts towards delivery nodes 13 and cluster 14. At the node level, rather than reacting when traffic load exceeds a degradation threshold or drops below a resume threshold, pulse based network traffic throttling proactively, and continuously, steers traffic load towards an optimal target band by determining the traffic load at predefined and regular time intervals and by taking decisions to change (or not) the state of the node accordingly. Pulse based network traffic throttling makes maximum use of the available infrastructure through more effective load management than other mechanisms. In this manner, overload and underuse situations can be avoided.

New requests for content are redirected to delivery nodes 13 based on node state BLOCKED or UNBLOCKED, and geographical proximity to the content consumers. The relationship of periods of UNBLOCKED to periods of BLOCKED create pulses controlled by the delivery node to maintain the traffic load within an optimal band.

The state of the node changes frequently, for example at time intervals of 100 milliseconds (ms), but can change more rapidly or more slowly. Traffic handling is normally toggled between STOP/BLOCKED and RESUME/UNBLOCKED at every time interval. New requests are directed to the most suitable UNBLOCKED delivery node nearest to the consumer content at any given time while established sessions continue to be serviced by the delivery node 13 to which they are connected. Delivery nodes 13 themselves decide whether they are available for new requests and availability changes rapidly.

The network controller 12 does not need to constantly monitor the delivery nodes 13. Instead it gets a notification of BLOCKED/UNBLOCKED state changes (if the state of the delivery node changes) at every time interval. The network controller 12 keeps a list of UNBLOCKED delivery nodes to which it distributes traffic based on its own load balancing logic. Thus it does not need to collect delivery node bandwidth usages (and other delivery node performance indicators) and to consider those factors in its logic of traffic distribution.

Delivery nodes 13 can be configured to operate independently, or in combination with other delivery nodes 13 as a cluster 14 of delivery nodes 13. Clusters provide redundancy and load balancing. To force a traffic distribution based on pulsing, the delivery nodes 13 toggles frequently between the states BLOCKED and UNBLOCKED. This toggling of the delivery nodes between the states BLOCKED and UNBLOCKED does not prevent the cluster from operating normally. The cluster as a whole is in a BLOCKED state only when all the delivery nodes therein are in the BLOCKED state. One mechanism to force toggling is to use a pair of upper and lower limits defining a single band towards which the traffic load should converge and within which the traffic load should ultimately be bound. The delivery node should therefore tend towards toggling between BLOCKED and UNBLOCKED states at every sampling interval to maintain traffic load within the band.

The toggling interval can preferably be every 100-500 milliseconds, but can occur more or less frequently depending on variables such as the average content size, usage patterns, time of day, and speed of infrastructure/equipment. The delivery node can be configured with initial parameters, including upper and lower limits and toggling interval, that can include different parameters for different times of the day, or operating conditions. The delivery node can further use these parameters to realize a self-tuning adaptive interval setting i.e. the toggling interval can be variable and continuously adapted according to a predictive algorithm, e.g. based on previous traffic load measurements and corresponding convergence rates of the delivery node. Such a predictive algorithm can also use current measurements such as traffic load, average content size, number of sessions, etc. as a basis for its computations. In a similar manner, the lower and upper limits can also be modified based on a predictive algorithm.

As the traffic load remains within the band, a toggling of state change occurs with every sampling interval. When outside the pair of upper and lower limits, the pulsing stops. When below the lower limit, the state remains UNBLOCKED and there is no halting of new connection creation, or provisioning of new sessions; when above the upper limit, the state remains BLOCKED there is no resuming of new connection creation, or provisioning of new sessions.

This toggling between states create alternating periods of “unrestricted traffic”, or bursts, alternated with periods of no traffic resulting in data pulses that repeats at every time interval.

This is different from traditional constraint-based traffic flow optimization systems that monitor network performance and react when the network performance crosses constraints—high mark and low mark thresholds—i.e. to correct overload situations and then resume normal unrestrained operation.

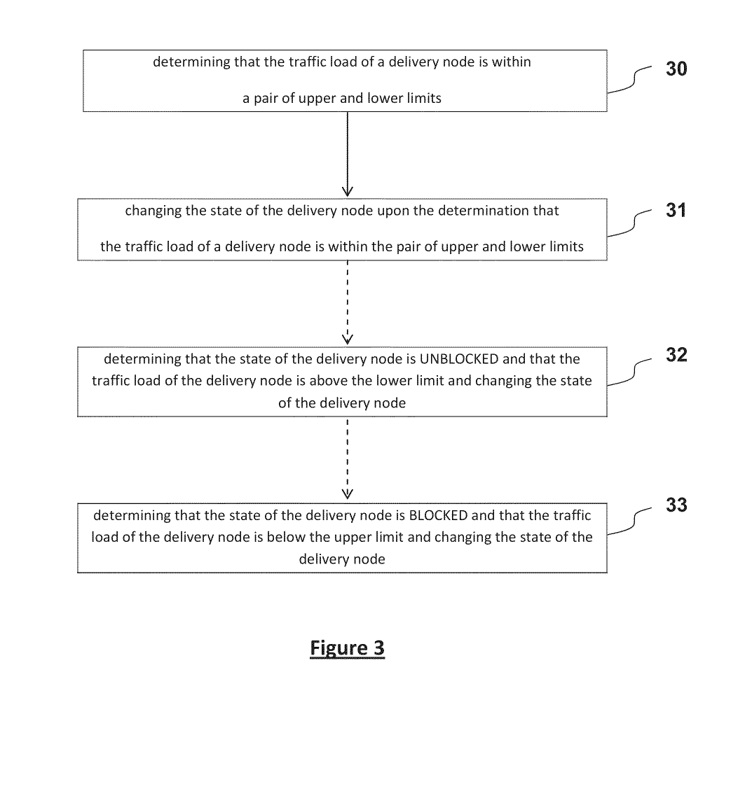

FIG. 3 illustrate steps of a method comprising a first step, 30, of determining that the traffic load of a delivery node is within a pair of upper and lower limits and a step, 31, of changing the state of the delivery node upon the determination that the traffic load of a delivery node is within the pair of upper and lower limits. When changing the state, the state is changed from UNBLOCKED to BLOCKED or from BLOCKED to UNBLOCKED.

The method may further comprise a step, 32, of determining that the state of the delivery node is UNBLOCKED and that the traffic load of the delivery node is above the lower limit and changing the state of the delivery node. The method may further comprise a step, 33, of determining that the state of the delivery node is BLOCKED and that the traffic load of the delivery node is below the upper limit and changing the state of the delivery node.

Only new session requests are blocked when the delivery node is in the BLOCKED state and current sessions continue to be served by the delivery node when the delivery node is in the BLOCKED and UNBLOCKED states. The delivery node can be part of a cluster of delivery nodes sharing a cumulative traffic load and new session requests are distributed to delivery nodes in an UNBLOCKED state.

The step of determining that the traffic load of a delivery node is within a pair of upper and lower limits of the method is executed at time intervals comprised within 100 to 500 milliseconds, but preferably at time intervals of 100 milliseconds. The traffic load can be determined by measuring used bandwidth or processor load. Typically, the load at the transceiver is measured and indicates the traffic load. Further, a person skilled in the art will readily understand that if the constraints of a network would allow it, the time interval can be outside the range provided above.

The method provides that the pair of upper and lower limits are configurable parameters that can vary according to operating conditions, time of day, day of week. And the time intervals is a configurable parameter that can vary according to average content size, usage patterns, time of day, day of week, speed of the delivery node or speed of communication links to the delivery node. Communication links can comprise elements such as network interface cards, routers, switches, cabling, link aggregation, etc.

The pair of upper and lower limits can be expressed in terms of a percentage of a maximum traffic load which the delivery node can serve or process, the percentages can be in the range comprised within 15% to 35% for the lower limit and 30% to 50% for the upper limit. Exemplary preferred limits may be 33% for the upper limit and 27% for the lower limit. However, a person skilled in the art will readily understand that if the constraints of a network would allow it, these limits can be outside the ranges provided above.

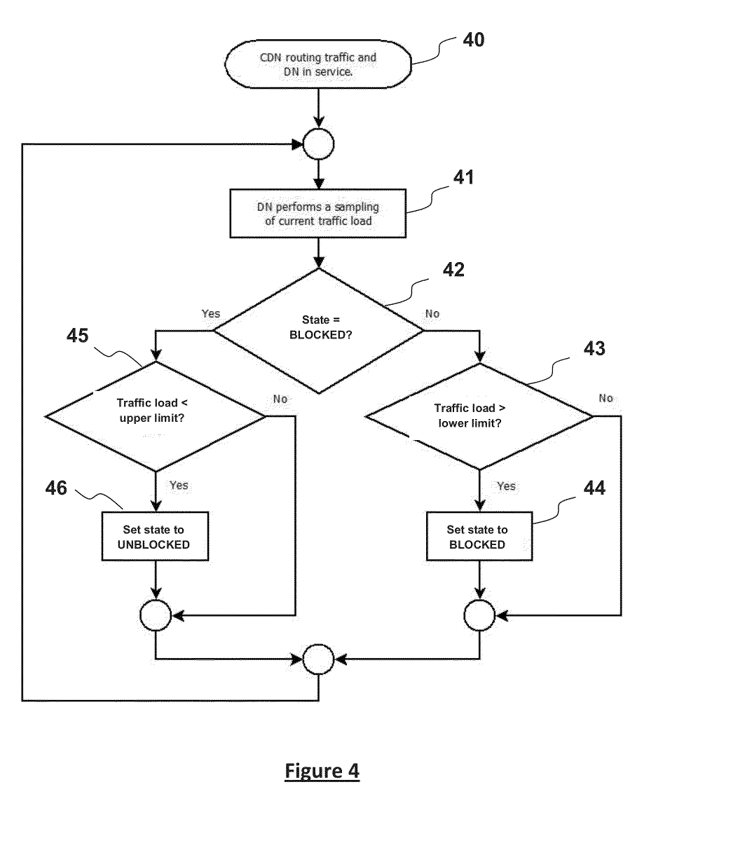

Referring now to FIG. 4, we assume that the CDN is routing traffic and that the delivery node 13 is in service, at box 40. At box 41, the delivery node 13 preforms a sampling of its current traffic load, which can be measured as the bandwidth used on the CC side of the delivery node or cluster, or by some other performance measure such as the processor load.

At decision box 42, which is executed at a regular interval, e.g. every 100 ms, the delivery node 13 determines if it is currently processing new requests, i.e. if it is in the state UNBLOCKED (not BLOCKED). If it is not blocked, at decision box 43, there is a check whether the traffic load is above the lower limit. The pair of upper and lower limits defines a target band considered optimal bandwidth usage on the infrastructure. If the traffic load is above the lower limit, i.e. is within the band (or above the band), then the delivery node toggles itself into a “not serving traffic”, BLOCKED, state, box 44.

Similarly, at the next sampling period, if the delivery node 13, or cluster 14, determines, at box 42, that it is currently not processing requests, state BLOCKED, then the traffic load, or performance measure, is compared against the upper limit, at box 45. If the traffic load is below the upper limit, i.e. is within the band (or below), then the delivery node toggles itself into a “serving traffic”, UNBLOCKED, state, box 46.

This process, of toggling between provisioning new traffic and not provisioning new traffic, repeats at every time interval. This toggling creates the following behavior. Given the optimal band of operation is within the pair of upper and lower limits, at every time interval, if the factor being measured (e.g. bandwidth) is within the optimal band of operation, the delivery node changes its state of operation from BLOCKED to UNBLOCKED or vice versa. If the factor being measured (e.g. bandwidth) is below the optimal band of operation, the delivery node becomes (or stays) UNBLOCKED and if the factor being measured (e.g. bandwidth) is above the optimal band of operation, the delivery node becomes (or stays) BLOCKED.

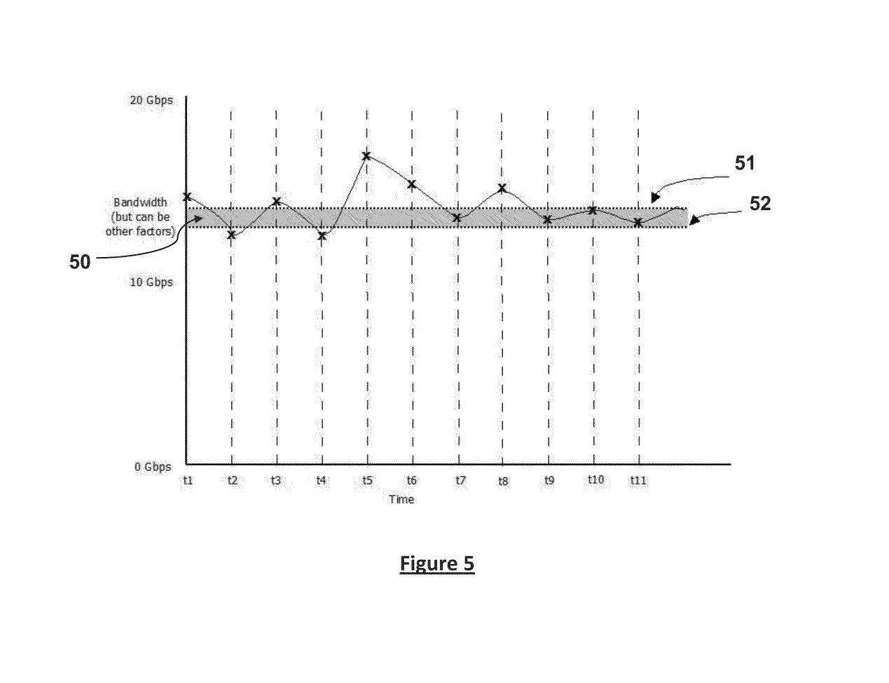

FIG. 5 is a graph illustrating an exemplary result of an execution of the methods of FIG. 3 or 4. FIG. 5 shows the load of a delivery node 13 over time. The band 50 is defined by the pair of upper 51 and lower 52 limits, which are, in this example, 14 Gbps for the upper limit 51 and 13 Gbps for the lower limit 52. It will be apparent to a person skilled in the art that such exemplary limits in Gbps are only given for the purpose of illustration, as network speed is increasing rapidly.

An exemplary sequence of events will now be described in relation with FIG. 5. Before time t1 the delivery node 13 is in the UNBLOCKED state. At t1 the DN 13 toggles to the state BLOCKED because the traffic load is above the band 50. No new requests are directed to the delivery node and the total node load declines as sessions terminate and/or requests are responded to due to end of media or user aborting. At time t2 the delivery node is in the BLOCKED state, it toggles to UNBLOCKED because the traffic load is now under the band 50 (not above the lower limit). New requests are directed to the delivery node. These sessions are provisioned and traffic load begins to increase again. The process continues and at time t3 the state changes from UNBLOCKED to BLOCKED because the traffic load is above the band 50 (not below the upper limit) and, again, no new requests are directed to the node. The node total traffic load declines. The process still continues at time t4 when the state changes from BLOCKED to UNBLOCKED because the total traffic load is below the band 50 (not above the lower limit). The traffic load again begins to increase.

Between sampling interval t4 and t5 there is a large increase in traffic load. At time t5, the load has risen quite high to about 17 Gbps. The node toggles from unblocked to blocked. Traffic load begins to decline. At time t6 the node would have normally toggled again to an unblocked state, but at this time the load remains above the band 50 (not below the upper limit), so no state change occurs. Traffic continues to decline. At time t7 the load has subsided further, and is now within the band 50, within the upper 51 and lower 52 limits. The state changes from BLOCKED to UNBLOCKED. From this point to time t11 the process continues normally with a state change at every sampling interval to converge starting at t9.

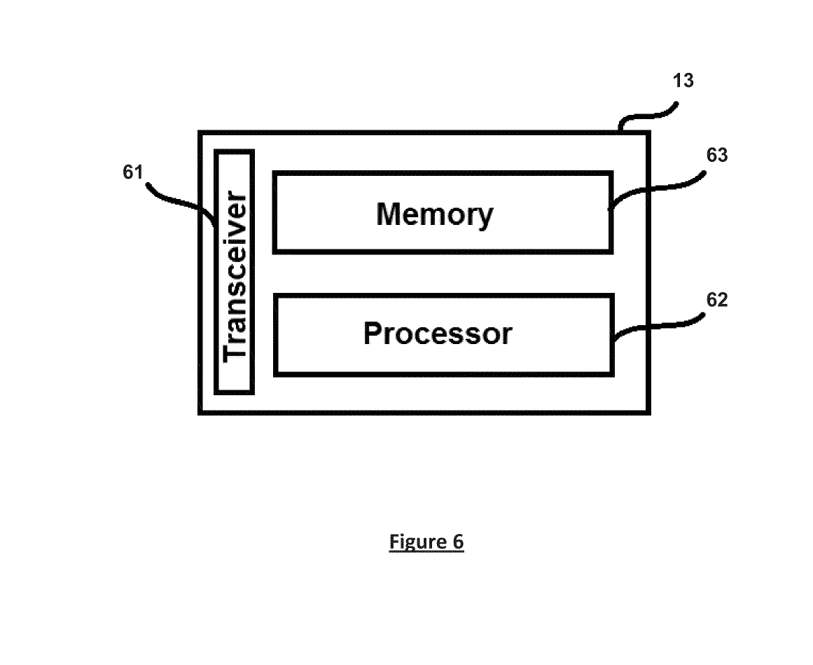

FIG. 6 is a block diagram of a delivery node 13 suitable for implementing aspects of the embodiments and methods disclosed hereinabove. The delivery node 13 includes a transceiver 61 which acts as a communications interface. The transceiver 61 generally includes analog and/or digital components for sending and receiving communications to and from other nodes, either directly or via a network. Those skilled in the art will appreciate that the block diagram of the delivery node 13 necessarily omits numerous features that are not necessary for a complete understanding of this disclosure.

Although all of the details of the delivery node 13 are not illustrated, the delivery node 13 comprises one or several general-purpose or special-purpose processors 62 or other microcontrollers programmed with suitable software programming instructions and/or firmware to carry out some or all of the functionality of the delivery node 13 described herein. In addition, or alternatively, the delivery node 13 may comprise various digital hardware blocks (e.g., one or more Application Specific Integrated Circuits (ASICs), one or more off-the-shelf digital or analog hardware components, or a combination thereof) (not illustrated) configured to carry out some or all of the functionality of the delivery node 13 described herein. A memory 63, such as a random access memory (RAM), may be used by the processor 62 to store data and programming instructions which, when executed by the processor 62, implement all or part of the functionality described herein. The delivery node 13 may also include one or more storage media (not illustrated) for storing data necessary and/or suitable for implementing the functionality of toggling and load management described herein, as well as for storing the programming instructions which, when executed on the processor 62, implement all or part of the functionality described herein. One embodiment of the present disclosure may be implemented as a computer program product that is stored on a computer-readable storage medium, the computer program product including programming instructions that are configured to cause the processor 62 to carry out the steps described herein.

The methods and delivery node 13 described herein allow the selection of delivery nodes 13 through traffic throttling as part of overall traffic optimization and provides opportunities for CDN owners to achieve reduced infrastructure needs by using more efficiently the existing infrastructure. These methods further allow an increased QoE for CCs, by preventing surges that can momentarily overload delivery nodes causing video playback to stall, for example.

Compared to traditional approaches the methods and delivery node described herein allow to maintain traffic load within an acceptable range. Pulse based throttling permits networking infrastructure to be used to its maximum capabilities while not introducing recovery delays leading to delivery nodes deviating from optimal usage loads. Pulse based throttling, with a single band, implements a proactive load control maintaining the traffic load within a narrower amplitude, oscillating around a point closer to the most cost effective operational level of the delivery nodes and network infrastructure. With pulse based throttling the traffic is controlled to avoid overloaded and underused situations.

With pulse based throttling there are more frequent adjustments to the delivery node load. The load is being steered to the optimal load band at every time interval. Furthermore, Pulse-based throttling allows decentralization of decision logic to the delivery nodes to optimize delivery for any particular geographical area. The optimal band of operation and time intervals may vary from one delivery node to another due to various hardware and connectivity differences. Each delivery node attempts to keep its own operation within an optimal band of operation.

The invention has been described with reference to particular embodiments. However, it will be readily apparent to those skilled in the art that it is possible to embody the invention in specific forms other than those of the embodiments described above. The described embodiments are merely illustrative and should not be considered restrictive in any way. The scope of the invention is given by the appended claims, rather than the preceding description, and all variations and equivalents that fall within the range of the claims are intended to be embraced therein.

1. A method for managing the traffic load of a delivery node being in a state BLOCKED or UNBLOCKED, comprising the steps of:
determining that the traffic load of the delivery node is within a pair of upper and lower limits; and
changing the state of the delivery node upon the determination that the traffic load of the delivery node is within the pair of upper and lower limits;
wherein changing the state is changing from UNBLOCKED to BLOCKED or from BLOCKED to UNBLOCKED.

2. The method of claim 1 wherein only new session requests are blocked when the delivery node is in the BLOCKED state and wherein current sessions continue to be served by the delivery node when the delivery node is in the BLOCKED and UNBLOCKED states.

3. The method of claim 2 wherein the delivery node is part of a cluster of delivery nodes sharing a cumulative traffic load and wherein new session requests are distributed to delivery nodes in an UNBLOCKED state.

4. The method of claim 1 further comprising the steps of determining that the state of the delivery node is UNBLOCKED and that the traffic load of the delivery node is above the lower limit and changing the state of the delivery node.

5. The method of claim 1 further comprising the steps of determining that the state of the delivery node is BLOCKED and that the traffic load of the delivery node is below the upper limit and changing the state of the delivery node.

6. The method of claim 1 wherein the step of determining is executed at time intervals comprised within 100 to 500 milliseconds.

7. The method of claim 1 wherein the traffic load is determined by measuring used bandwidth or processor load.

8. The method of claim 1 wherein the pair of upper and lower limits are configurable parameters that can vary according to operating conditions, time of day, day of week and wherein the time intervals is a configurable parameter that can vary according to average content size, usage patterns, time of day, day of week, speed of the delivery node or speed of communication links to the delivery node.

9. The method of claim 8 wherein the pair of upper and lower limits are percentage values expressed in terms of a percentage of a maximum traffic load which the delivery node can serve, said percentages being in the range comprised within 15% to 35% for the lower limit and 30% to 50% for the upper limit.

10. A delivery node comprising a processor and memory, said memory containing instructions executable by said processor for managing the traffic load of the delivery node which is in a state BLOCKED or UNBLOCKED, whereby said delivery node is operative to:
determine that the current traffic load of the delivery node is within a pair of upper and lower limits; and
change the state of the delivery node upon the determination that the traffic load of the delivery node is within the pair of upper and lower limits;
wherein the state is changed from UNBLOCKED to BLOCKED or from BLOCKED to UNBLOCKED.

11. The delivery node of claim 10 wherein only new sessions requests are blocked when the delivery node is in the BLOCKED state and wherein current sessions continue to be served by the delivery node when the delivery node is in the BLOCKED and UNBLOCKED states.

12. The delivery node of claim 11 wherein the delivery node is part of a cluster of delivery nodes sharing a cumulative traffic load and wherein new session requests are distributed to delivery nodes in an UNBLOCKED state.

13. The delivery node of claim 10 whereby said delivery node is further operative to determine that the state of the delivery node is UNBLOCKED and that the traffic load of the delivery node is above the lower limit and change the state of the delivery node.

14. The delivery node of claim 10 whereby said delivery node is further operative to determine that the state of the delivery node is BLOCKED and that the traffic load of the delivery node is below the upper limit and change the state of the delivery node.

15. The delivery node of claim 10 wherein the determination is executed at time intervals comprised within 100 to 500 milliseconds.

16. The delivery node of claim 10 wherein the traffic load is determined by measuring used bandwidth or processor load.

17. The delivery node of claim 10 wherein the pair of upper and lower limits are configurable parameters that can vary according to operating conditions, time of day, day of week and wherein the time intervals is a configurable parameter that can vary according to average content size, usage patterns, time of day, day of week, speed of the delivery node or speed of communication links to the delivery node.

18. The delivery node of claim 17 wherein the pair of upper and lower limits are percentage values expressed in terms of a percentage of a maximum traffic load which the delivery node can serve, said percentages being in the range comprised within 15% to 35% for the lower limit and 30% to 50% for the upper limit.
